(19) United States
(12) Patent Application Publication
(10) Pub. No.: US 2007/0226014 A1
(43) Pub. Date: Sep. 27, 2007

(54) System and method of classifying vehicle insurance applicants

(76) Inventors: Bisrat Alemayehu, Chanhassen, MN (US); Yeshihareg Agga, Eden Prairie, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/386,282

(22) Filed: Mar. 22, 2006

(51) Int. Cl. G06Q 40/00

(52) U.S. Cl. 705/4

(57) ABSTRACT

A method of evaluating insurance risk of a vehicle insurance applicant provides identifying a plurality of temporal identifiers related to acquired driving experience for the applicant, where the temporal identifiers include valid license duration, license elements duration, credit duration, no-need no-prior submission, learner permit duration, no license violation duration; and assigning a value to each of the identified temporal identifiers. The method includes identifying a plurality of exception identifiers related to a driving record of the applicant, where the exception identifiers include evidence of prior valid license, evidence of prior violations, evidence of accident record, and evidence of prior vehicle insurance; and assigning a value to each of the identified exception identifiers. The method includes calculating a driver rating based upon the value assigned to each of the temporal and exception identifiers, and classifying the applicant into categories of inexperienced adult driver, unverifiable driving history, or an inexperienced driver.

### THE FIELD OF THE INVENTION

The present invention relates to insurance underwriting, and more particularly, to evaluating an insurance risk level for a vehicle insurance applicant and classifying the applicant based upon the insurance risk level.

### BACKGROUND

Automobile insurance underwriting in the United States is traditionally based on a number of factors designed to classify applicants into an appropriate risk class. The factors used to determine risk class are deemed to be predictive of potential claims experience for members of each class. The risk class and tier within the class to which an applicant is assigned during the underwriting process will determine the premium that they are charged for automobile insurance. In aggregate, effective risk classification and tier assignment strive to achieve equity in the premiums charged to applicants for automobile insurance.

Factors employed in automobile insurance underwriting include an applicant's age, marital status, driving record, where the applicant lives (i.e., garaging address) and other household information, the type of automobile insured, and how the automobile will be used. Typically, this information is elicited by questions asked during application for automobile insurance and verified by reference to information in various data bases.

Another driver characteristic considered in setting automobile insurance rates is driver/operator experience. An inexperienced operator/driver will be charged a higher premium to cover the higher risk of claim and higher claim costs expected from such drivers. Generally, operators with less than 3 years of driving experience are considered to be inexperienced. However, drivers with less than 6 years of experience may be considered inexperienced operators by some insurers in some states and not eligible to qualify for preferred rates.

It is commonly recognized that younger drivers, for example under age 19, are inexperienced based on the assumption that most individuals cannot obtain a first driver's license and begin gaining driving experience until age 16 when they are first legally eligible to drive in most states. However, it is also true that a percentage of adult drivers do not have driving experience of, at least, three years when they apply for automobile insurance coverage and are, therefore, inexperienced operators/drivers.

A report issued to the Division of Insurance in April, 2004 by Tillinghast-Towers Perrin indicates that the frequency of inexperienced operators/drivers property damage and collision claims is four-times higher than experienced drivers, and the frequency of personal injury claims is six times higher than that of experienced drivers. See Table 1 below. This experience was based on Massachusetts-specific data and used as a basis for rate determinations in Massachusetts.

TABLE 1
Experienced vs. Inexperienced Operator Claims Frequency
(per 100 Vehicles)
2001-2003 Claims Frequency

| Drivers | PDL | PIP | Collision |
|---|---|---|---|
| Experienced Drivers w/6+ years | 6.07 | 2.47 | 8.34 |
| driving experience | | | |
| Inexperienced Drivers w/4-6 | 13.55 | 6.94 | 20.94 |
| years driving experience | | | |
| Inexperienced Drivers w/0-3 | 24.35 | 12.16 | 32.68 |
| years driving experience | | | |

Also, drivers with international driver's licenses or drivers with licenses that were issued by jurisdictions in other than the U.S. have driving histories that are unverifiable by automobile insurers in the U.S. It is recognized by some that, generally, such drivers are more likely to display poor driving skills until they gain experience in a U.S. driving environment. These drivers, generally, display higher claim risk and claim cost until they gain such experience. Therefore, it is desirable for an automobile insurance company to identify and place these individuals in higher risk categories so that automobile insurance premiums appropriate to the risk the insurance company is exposed to can be charged and premium equity among policyholders can be maintained.

For these and other reasons, there is a need for the present invention.

### SUMMARY

One aspect of the present invention provides a method of evaluating insurance risk of a vehicle insurance applicant. The method includes identifying a plurality of primary/temporal identifiers related to acquired U.S. driving experience for the applicant, where the primary/temporal identifiers are selected from the group including valid license duration, license elements duration, credit duration, prior insurance history as evidenced by a no-need no-prior submission, learner permit duration, no license violation duration. The method additionally includes assigning a value to each of the identified temporal identifiers. The method additionally includes identifying a plurality of exception identifiers related to a driving record of the applicant, where the exception identifiers are selected from the group including evidence of prior valid license, evidence of prior violations, evidence of accident record, and evidence of prior vehicle insurance. The method includes assigning a value to each of the identified exception identifiers. The method additionally includes calculating a driver rating based upon the value assigned to each of the temporal and exception identifiers, and classifying the applicant into one of an inexperienced adult driver category, an unverifiable driving history category, and an inexperienced driver category based upon the driver rating.

Another aspect of the present invention provides a method of evaluating an applicant for vehicle insurance. The method includes collecting a social security number supplied by the applicant, and analyzing the social security number. The method additionally includes classifying the applicant into one of an inexperienced adult driver category, an unverifiable driving history category, and an inexperienced driver category based upon the social security number.

Another aspect of the present invention provides a vehicle insurance underwriting system. The system includes a computer system, and a program operable by the computer system. In this regard, the program is operable to calculate a driver rating based upon comparing a plurality of temporal identifiers related to acquired driving experience for the applicant relative to a plurality of exception identifiers related to a driving record of the applicant, and classify the applicant into at one of an inexperienced adult driver category, an unverifiable driving history category, and an inexperienced driver category based upon the driver rating.

Aspects of the present invention provide for identifying adult inexperienced operators during underwriting for policy renewal.

Aspects of the present invention provide for an effective method to identify, determine and/or verify with repeatable and predictable certainty whether an adult operator/driver is an experienced vehicle operator.

Aspects of the present invention provide for an effective method to identify, determine and/or verify with repeatable and predictable certainty whether an adult operator/driver has an unverifiable driving record.

Aspects of the present invention enable an insurance provider to apply a repeatable and predictable system that quantifies an equitable automobile insurance rating for insurance applicants that is useful in determining vehicle premium rate structures that are fair for all policyholders.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates a flow diagram of a method of evaluating insurance risks of a vehicle insurance applicant according to one embodiment of the present invention.

FIG. 2 illustrates another flow diagram of a method of evaluating insurance risks of a vehicle insurance applicant according to one embodiment of the present invention.

FIG. 3 illustrates a vehicle insurance underwriting system according to one embodiment of the present invention.

FIG. 4 illustrates a flow diagram of a method of evaluating insurance risks of a vehicle insurance applicant according to another embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

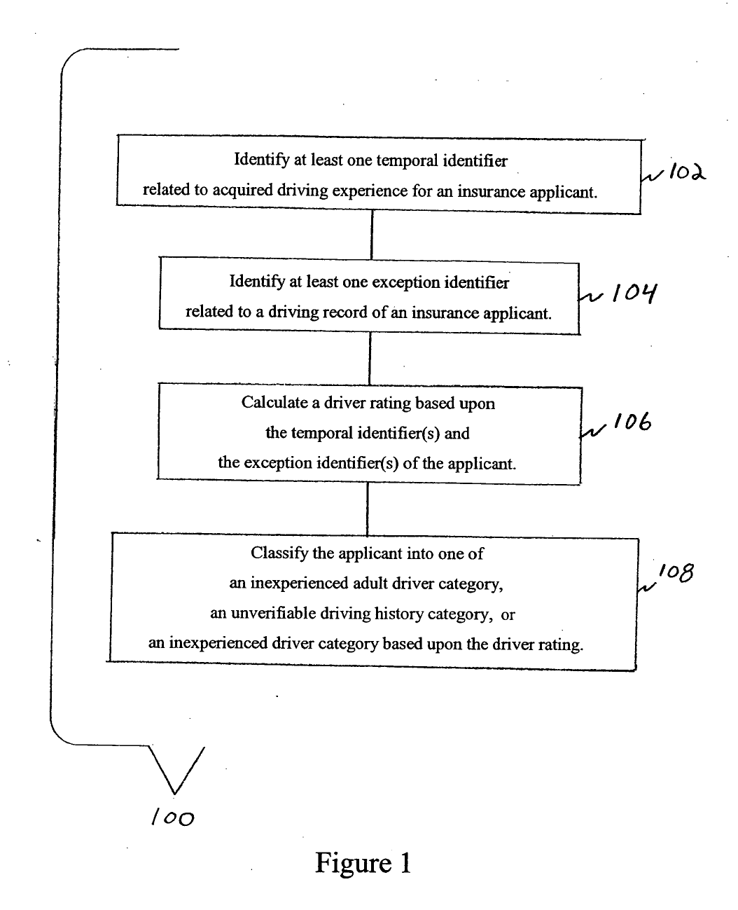

FIG. 1 illustrates a flow diagram for a method of evaluating insurance risks of a vehicle insurance applicant according to one embodiment of the present invention. The flow diagram in one embodiment includes an algorithm 100 that provides at 102 identifying at least one temporal identifier related to acquired driving experience for an insurance applicant. Algorithm 100 provides at 104 identifying at least one exception identifier related to a driving record of an insurance applicant. Algorithm 100 provides at 106 calculating a driver rating based upon the selected temporal identifiers and the selected exception identifiers for the applicant. Algorithm 100 provides at 108 classifying the applicant into one of an experienced adult driver category, an unverifiable driving history category, and an inexperienced driver category based upon the driver rating.

Throughout this Specification, the term temporal identifier is employed interchangeably with the term primary identifier. In this regard, “primary identifier” references an identifier or set of identifiers having a direct or indirect relationship to a span of time over the driving experience of the insurance applicant. “Primary identifier” does not reference an identifier having a “primary” importance; rather a primary identifier is a temporal identifier related to a span of time over the driving experience of the insurance applicant. Therefore, as employed throughout the Specification the term “primary identifier” is to be interpreted as a temporal identifier.

Temporal identifiers as identified in algorithm 100 at 102 include, for example, the time for which the insurance applicant has been in possession of a valid current driver's license, the time for which the insurance applicant has had elements characteristic of an issued adult driver's license and/or characteristics of a credit history file, the existence or non-existence of credit history and depth, the time over which no prior insurance policy was in effect for any reason, the time over which the insurance applicant held a valid driver's learner permit, and the time from which the insurance applicant has had a violation on the driving record for driving without a license.

Algorithm 100 provides at 104 identifying at least one exception identifier related to a driving record of the insurance applicant. Examples of exception identifiers include the time over which the insurance applicant at the time of insurance application has been in possession of a current valid U.S. driver's license, the existence of one or more traffic tickets on the insurance applicant's driving record for moving violations of greater than a specified number of years, the existence of one or more accident occurrences on the insurance applicant's driving record older than a specified number of years, the existence of prior automobile insurance coverage, for example, older than a specified number of years.

In general, the exception identifiers are employed to clarify and/or augment information related to the temporal identifiers. Exception identifiers, when applied, offset or reduce the level of risk that is implied or calculated based on one or more temporal identifiers. In this regard, where a temporal identifier might indicate that an applicant for vehicle insurance is at risk of being an inexperienced adult driver or a driver with an unverifiable driving history, the exception identifier(s) reduces that level of risk by offsetting or mitigating the weighing of the temporal identifiers. In one embodiment, the exception identifiers include information that weighs in favor of finding the adult driver to be experienced, or verifies the driver experience of greater than, for example, three years.

In one embodiment, the suitable exception identifiers are identified and evaluated without regard to temporal identifiers. For example, an exception identifier is used alone to classify an insurance applicant into a pool of applicants, that by qualifying with an exception identifier, identifies (or pools) the applicant as a driver with experience. In this regard, a driver so classified would not be further checked by the insurance provider for driving experience because that applicant has been identified by the exception identifier as experienced. In contrast, the exception identifier can be used alone without a temporal identifier to identify those applicants who are inexperienced (i.e., having few or no qualifying exception identifiers), and thus “pooled” for further checking by the insurance provider.

Temporal identifiers and exception identifiers can be selected, verified, and quantified from information databases, including for example, government and public information databases. In one embodiment, information databases useful in identifying temporal identifiers include Department of Motor Vehicle (DMV) databases, Internal Revenue Service databases, Social Security Administration databases, and credit bureau databases, and other similar databases, available to insurance underwriters and agents with or without a fee.

Algorithm 100 provides at 106 calculating a driver rating based upon temporal identifiers and exception identifiers of the applicant. In one embodiment, the calculation of a driver rating includes assigning a value to each identified temporal and exception identifier(s). The value assigned to the temporal and exception identifier(s) in one embodiment is arbitrary. In another embodiment, the value assigned to the temporal and exception identifier(s) is derived from data tabulated by the insurance provider, and can include weighting for characteristics that are preferred by the insurance provider. In one embodiment, the calculation of a driver rating is based upon a sum of the values for the temporal identifiers less the value assigned for any exception identifiers, thus providing a net sum indicative of a driver rating. In one embodiment, a probability factor is assigned to a driver rating, where the probability factor is useful to insurance underwriters during a follow up of the applicant by an insurance agent or agency during directed field underwriting. Directed field underwriting provides a mechanism by which the insurance agent/agency can confirm or modify the presumption of inexperience, or the existence of an unverifiable driving history.

Algorithm 100 at 108 classifies the applicant into a driver category. Aspects of the present invention provide for an effective method to identify, determine, and/or verify with repeatable and predictable certainty whether an adult operator/driver is an experienced vehicle operator. In addition, aspects of algorithm 100 provide for an effective method to identify, determine, and/or verify with repeatable and predictable certainty whether an adult operator/driver has an unverifiable driving record.

In this Specification, the terms “underwrite” and “underwriting” mean accepting or assuming an insurance risk when issuing a driver an insurance policy, or alternatively, classifying/evaluating an insurance risk and offering a driver an insurance policy at a specified premium, or alternatively, declining to offer an insurance policy to the applicant.

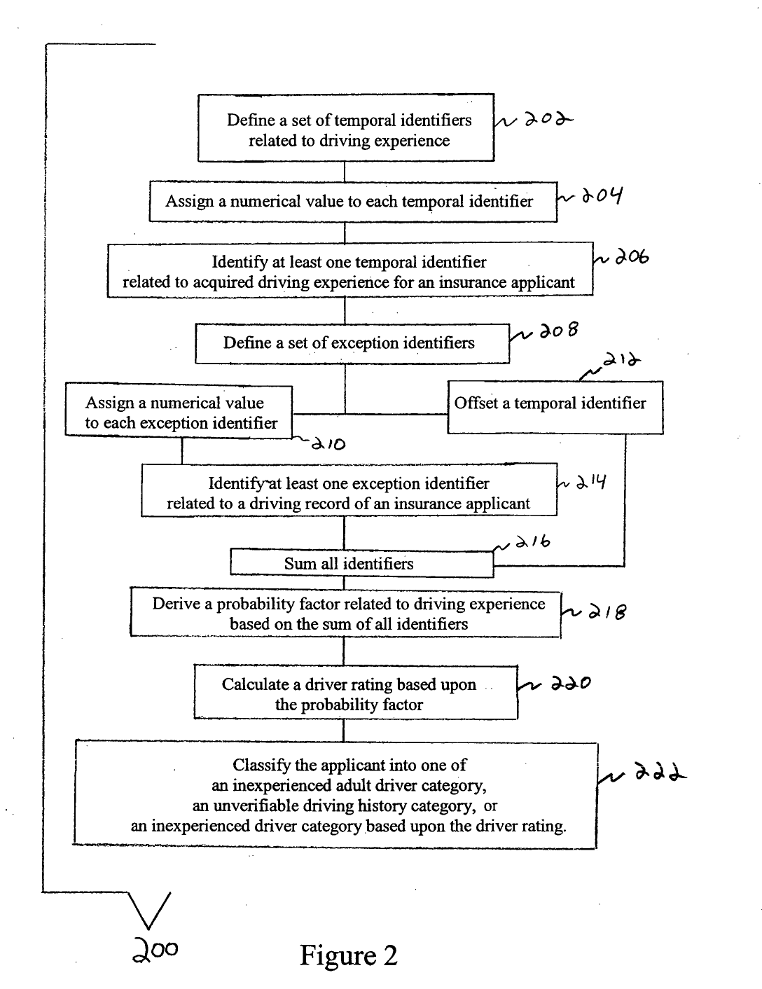

FIG. 2 illustrates a flow diagram for a method evaluating insurance risks of a vehicle insurance applicant according to another embodiment of the present invention. The flow diagram in one embodiment includes an algorithm 200 including process 202 that defines a set of temporal identifiers relating to driving experience. Process 204 provides assigning a numerical value to each temporal identifier. Process 206 provides identifying at least one temporal identifier related to acquired driving experience for an insurance applicant. Process 208 provides defining a set of exception identifiers. In one embodiment, process 210 provides assigning a numerical value to each exception identifier. In another embodiment, process 212 provides for offsetting a temporal identifier with, for example, one or more of the exception identifiers. Process 214 provides identifying at least one exception identifier related to a driving record of an insurance applicant. Process 216 provides a summation of all selected identifiers relevant to the insurance applicant. Process 218 provides deriving a probability factor related to driving experience based on the appropriate sum or difference (depending on the mathematical sign of the number being manipulated) of all selected temporal and exception identifiers. In FIG. 2, summing identifiers accounts for whatever mathematical sign (positive or negative) that the value has when the probability factor is computed. Process 220 provides calculating a driver rating based upon the probability factor. Process 222 provides classifying the applicant into one of an experienced adult driver category, an unverifiable driving history category, or an inexperienced driver category based upon the driver rating.

Algorithm 200 provides at process 204 assigning a numerical value to each temporal identifier. In one embodiment, the numerical value is assigned based upon a “year” variable. In this regard, the “year” variable is determined based upon a category that represents a number of years for which the temporal identifier has existed for the insurance applicant. For example, the numerical value can be assigned as determined with reference to a suitable information database, for example, a DMV record database.

In one embodiment, process 210 provides for assigning a numerical identifier to each exception identifier. The numerical value assigned to the exception identifiers includes real numbers of a similar type of the numerical value assigned to the temporal identifiers. For example, in one embodiment a driver rating is calculated based upon subtracting the numerical value of the exception identifier from the numerical value of the temporal identifier.

In another embodiment, an exception identifier is identified and employed to offset one or more temporal identifiers. In this regard, an exception identifier can reduce to zero one or more temporal identifiers, thus affecting the calculation of the driver rating.

Process 218 provides driving a probability factor related to driving experience based upon the sum/difference of all identifiers. In one embodiment, the probability factor is a point value that can be used to drive underwriting follow-up to be applied by the insurance agent or agency involved in the auto insurance sale. For example, the probability is indicative of a risk level of the insurance applicant that can be confirmed or denied by the insurance agent or agency during a directed field underwriting. In this regard, the directed field underwriting done during the follow-up process is useful in either confirming or modifying the presumption of inexperience, or the presumption of unverifiable driving history of the insurance applicant.

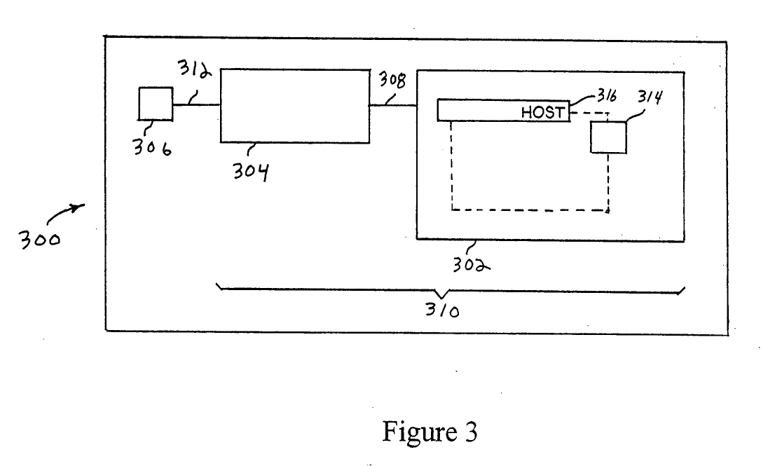

FIG. 3 illustrates a vehicle insurance underwriting system 300 according to one embodiment of the present invention. System 300 includes a server 302, a program 304, and an electronic device 306 having access to the program 304. In general, the server 302 and the program 304 communicate via a connection 308 and form a client-server system 310. When a user of the electronic device 306 accesses the client-server system 310 via an access connection 312, the program 304 communicates with the server 302 via the connection 308 such that the client-server system 310 interacts with a data retrieval system 314.

In one embodiment, the server 302 resides on a site of a distributed communication system, and is a program that responsively interacts with the client program 304. In one embodiment, the server 302 includes a host 316 providing access to the data retrieval system 314. In one embodiment, access to the logical data retrieval system 314 is gained via registering through the host 316 and is fee-based.

In one embodiment, the program 304 is a program that resides at a site on the distributed communication system and is configured to query a separate program at a separate site (for example, the host 316) on the distributed communication system. In this regard, the client program 304 is a requesting program configured to “talk” to the server 302.

The electronic device 306 can be any device configured to access the client program 304. For example, the electronic device 306 can include a computer, a personal data assistant such as a Blackberry™ personal data assistant, a cellular phone having Internet access, or any other device having access to the worldwide web (i.e., a hypermedia interface for viewing and exchanging information represented as WWW). To this end, in one embodiment the connection 312 is an Internet web connection operable through a browser, useful in both calculating a driver rating based upon the identifiers, and transmitting insurance quotes to the applicant. With this in mind, the connection 312 can include hard wired connections, or alternatively, wireless connections, between the electronic device 306 and the client-server system 310.

In one embodiment, the local data retrieval system 314 is a program operable by a computer system. In this regard, program 314 can include operand manipulative fields, and can include formatted data compiled, for example, on a DVM database.

Regarding the Primary Identifiers, in one embodiment a set of Primary Identifiers is employed that have a direct or indirect relationship to the number of years of driving experience for the insurance.

In another embodiment, the set of Primary Identifiers have a direct or indirect relationship to the likelihood that an adult driver only has driving experience outside of the U.S., and indicates that the driver has an unverifiable driving history.

Such sets of Primary Identifiers can be selected such that they are easily verified from information data bases that are available or developed by an automobile insurance writer. The Primary Identifiers can also be selected such that they identify a potential additional risk of an inexperienced adult operator/driver or an adult driver with driving experience only outside of the U.S. Primary Identifiers can be indicative of additional risk, or alert a writing agent to the presence of additional risk to be verified through a field underwriting process.

In one embodiment, a rating system can be used to assign a weight or numerical point value to each Primary/Temporal Identifier as an indication of the value or relative importance each Primary Identifier has in establishing a probability that an adult driver has either (1) the characteristic of being inexperienced or (2) having only driving experience gained outside of the U.S. The rating system can include an initial rating system which may be adjusted over time as the method is applied and experience is gained with respect to the accuracy of its predictive value.

The accuracy or predictive value of the above-noted rating system can be a function of the Primary Identifiers used and/or the addition of other Primary Identifiers. Therefore, the addition of Primary Identifiers and improvements in the reliability of the Primary Identifiers that are used may result in a revision of the rating system in terms of the weights or point values assigned to each Primary Identifier.

In addition, the above-noted rating system can take different forms to satisfy the needs of different automobile insurance markets. For example, the information required to assign a weight or point value to a Primary Identifier may vary by insurance market, company and geographic region or state. The weight or point value assigned to a primary identifier may also vary by insurance market, company and geographic region or state. The Primary Identifiers can vary in scope/quantity as the data employed to establish a Primary Identifier may not be available, or may not be available on a timely basis in some selling environments, for example, over the Internet. In addition, in different selling environments it may be considered appropriate to use different sets of Primary Identifiers and, therefore, have different rating systems.

Therefore, aspects of this invention encompass the use of different rating systems in different selling environments and rating systems which may be adjusted over time to accommodate improvements in the quality or availability of information used to establish the Primary Identifiers.

In one embodiment, a set of Exception Identifiers is also identified. Such sets of Exception Identifiers can be selected such that they are verified from information data bases that are readily available, developed or which may become readily available to an automobile insurance writer. The sets of Exception Identifiers can provide information that contradicts or clarifies the meaning of a Primary Identifier such that the potential additional risk due to an insurance applicant being an inexperienced adult operator/driver or an adult driver with driving experience only outside of the U.S. implied by having an unverifiable driving history is reduced and/or eliminated.

In one embodiment, the Exception Identifiers are assigned negative weights or point values in the rating systems used. The rating systems incorporate negative weight or numerical point value assignments to the Exception Identifiers in a way similar to that used for the Primary Identifiers. Adjustments, modifications, or improvements in the negative weights and numerical point values assigned to the Exception Identifiers in the rating systems are made for the same reasons and in the same way as for the Primary Identifiers, as described above.

### EXAMPLE 1

Social Security Number Employed to Classify the Applicant

In one embodiment, an applicant for vehicle insurance is evaluated based upon the applicant's social security number (SSN) used as a primary/temporal identifier. For example, the social security number is supplied by the applicant when requested by the insurance provider, and the insurance provider analyzes the social security number. The insurance provider can analyze the SSN in a variety of ways, including using public lookup tables having SSN information tabulated, accessing secure government databases having SSN information tabulated, and accessing proprietary databases that provide a range of information correlated to SSN. Based upon the analysis, the insurance provider classifies the applicant into one of an inexperienced adult driver category, an unverifiable driving history category, or an inexperienced driver category based upon the social security number.

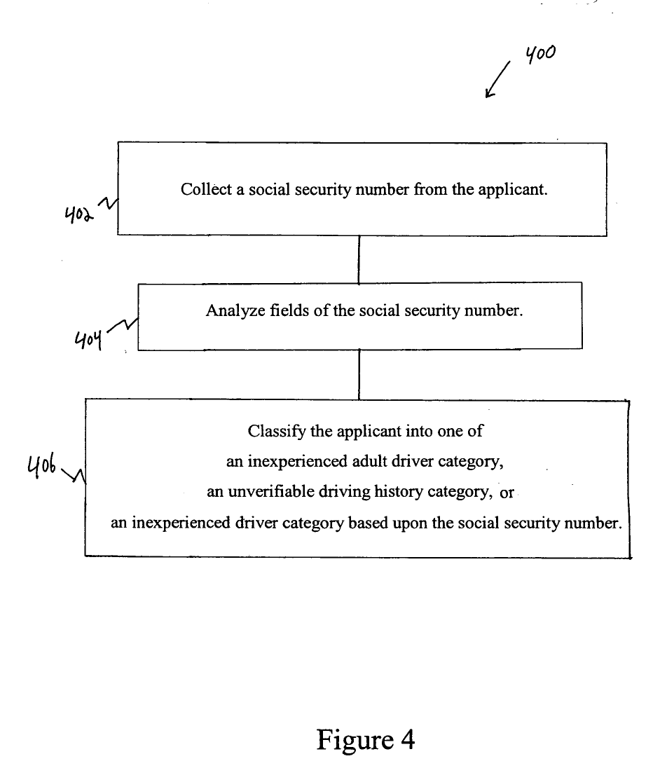

FIG. 4 illustrates a flow diagram of a method of evaluating insurance risks of a vehicle insurance applicant according to another embodiment of the present invention. The flow diagram in one embodiment includes an algorithm 400 that provides at 402 collecting a social security number from an insurance applicant. Algorithm 400 provides at 404 analyzing fields of the SSN. Algorithm 400 provides at 406 classifying the applicant into a driver category based upon the analysis of the SSN.

In general terms, the nine-digit SSN is composed of three parts: The first set of three digits is the Area Number; the second set of two digits is the Group Number; and the final set of four digits is the Serial Number.

The Area Number is assigned by geographical region. Prior to 1972, SSN cards were issued in local Social Security offices around the country and the Area Number represented the State in which the card was issued. This was not necessarily the State where the applicant lived, since a person could apply for a SSN card in any Social Security office. Since 1972, when the Social Security Administration began assigning SSNs and issuing cards centrally from Baltimore, Md., the area number assigned has been based on the ZIP code in the mailing address provided by the applicant. The applicant's mailing address does not have to be the same place as their residence.

Generally, SSNs were assigned beginning in the northeast and moving westward. So people on the east coast have the lowest numbers and those on the west coast have the highest numbers.

Within each area, the group numbers (middle two digits) range from 01 to 99 but are not assigned in consecutive order. For administrative reasons, group numbers issued first consist of the ODD numbers from 01 through 09 and then EVEN numbers from 10 through 98, within each area number allocated to a State. After all numbers in group 98 of a particular area have been issued, the EVEN Groups 02 through 08 are used, followed by ODD Groups 11 through 99. In one embodiment, group numbers include date of SSN issuance, and other encoded.

Within each group, the serial numbers (last four (4) digits) run consecutively from 0001 through 9999.

For example, an adult applicant for vehicle insurance in Minnesota supplies a SSN to a Minnesota insurance provider. The SSN takes the form XXX-YY-ZZZZ. The XXX provides the area number data, the YY provides the group number data, and the ZZZZ provides the serial number data. The insurance provider analyzes the social security number and first interprets the area number data (for example XXX=247) to indicate that the applicant had the SSN issued to a South Carolina zip code address. Thus, the applicant is not an experienced Minnesota driver, although the applicant might be an experienced driver moving from South Carolina to Minnesota.

The insurance provider further analyzes the social security number, for example the group number, and interprets the group number to indicate that the applicant first had the SSN (247-YY-ZZZZ) issued two years previously (to the South Carolina address). In this manner, the insurance provider, by analyzing the SSN, is able to classify the applicant as an inexperienced adult driver based solely upon the SSN information supplied by the applicant.

Subsequent to the Social Security Amendments of 1972 (P.L. 92-603), SSNs are issued to all legally admitted aliens upon entry, and to anyone upon receiving or applying for any benefit paid for by Federal funds. Subsequent to 1987, the Social Security Administration issued SSNs for newborn infants upon registration of the birth with the state. SSNs are employed as identifying documents related to the issuance of driver's licenses. In this regard, an adult vehicle insurance applicant who received a SSN two years prior to the application for insurance has a high probability of being an inexperienced operator.

In other embodiments, more than one temporal identifier is identified and weighted, and more than one exception identifier is identified and weighted, and based upon the temporal and exception identifiers the insurance provider is able to classify the applicant into an appropriate driver category.

Additional Primary/Temporal Identifiers

Primary/Temporal Identifier #1.

If the result of this calculation is less than 3, Table 2 can be employed to assign a probability that the applicant was an inexperienced adult driver with less than 3 years of US driving experience. Table 2 illustrates a probability associated with the number of years a valid operator's license has been held. Using the result of the calculation, together with the age of the driver and the state of residence, a probability will be assigned by referring to the appropriate column and row in the table.

In this regard, if a driver license is in existence, the date of issuance is useful in determining whether the applicant is an inexperienced adult driver with less than 3 years of US driving experience. If the driver license only indicates a date of expiration, then the term of the driver license period less the difference between the date of expiration/the date of application for insurance provides guidance as to whether the applicant is an inexperienced adult driver with less than 3 years of US driving experience.

For example, if a 25 year old operator/driver were licensed in a state which had a 4 year renewal period and the result of the calculation was less than 3 but greater than 2, a probability of 50% might be assigned to this Primary Indicator or a point value of, say, 8 (in, for example, a 10 point system) might be assigned. In one embodiment, the assignment of a probability factor or point value to a Primary Indicator is based upon an arbitrary value selected by an insurance provider based upon experience and/or factors not derived from the data provided by the applicant. Table 2 is illustrative only and other suitable tables may be used. For example, a table in which the result of the calculation of Primary Identifier #1 was 5 or less could be considered to identify drivers with less than 5 years of US driving experience.

The date of issue and/or expiration date of an applicant's current valid driver license is documented on the individual driver licenses held by applicants and can be elicited by questions asked on an application for automobile insurance. The information provided can be collaborated and verified by the individual state department of motor vehicle (DMV) records.

The weight or point value result for Primary Identifier #1 in combination with the weights or point values for other Primary and Exception Identifiers are used to determine the probability that the applicant was an inexperienced adult operator/driver.

TABLE 2
Inexperienced Operator Identifier (Probability %)

| | License Renewal Term (years) | | | | | | | | | | |
|---|---|---|---|---|---|---|---|---|---|---|---|
| | 2 | | | | | | | | | | |
| | 1 of 51 | | 4 | | | 5 | | | 6 | | |
| | states | | 24 of 51 States | | | 17 of 51 States | | | 6 of 51 States | | |
| Age of Driver | <1 | <2 | <1 | <2 | <3 | <1 | <2 | <3 | <1 | <2 | <3 |
| 16-18 | 100 | 100 | 100 | 100 | 100 | 100 | 100 | 100 | 100 | 100 | 100 |
| 19 | 50 | 100 | 100 | 100 | 100 | 100 | 100 | 100 | 100 | 100 | 100 |
| 20 | 50 | 100 | 100 | 100 | 100 | 100 | 100 | 100 | 100 | 100 | 100 |
| 21 | 33.3 | 50 | 50 | 100 | 100 | 100 | 100 | 100 | 100 | 100 | 100 |
| 22 | | 50 | 50 | 50 | 100 | 50 | 100 | 100 | 100 | 100 | 100 |
| 23 | | 33.3 | 50 | 50 | 50 | 50 | 50 | 100 | 50 | 100 | 100 |
| 24 | | | 50 | 50 | 50 | 50 | 50 | 50 | 50 | 50 | 50 |
| 25 | | | 33.3 | 33.3 | 50 | 50 | 50 | 50 | 50 | 50 | 50 |
| 26 | | | | | 50 | 50 | 50 | 50 | 50 | 50 | 50 |
| 27 | | | | | 33.3 | 33.3 | 50 | 50 | 50 | 50 | 50 |
| 28 | | | | | | | 50 | 50 | 50 | 50 | 50 |
| 29 | | | | | | | 33.3 | 33.3 | 33.3 | 50 | 50 |
| 30 | | | | | | | | | | 33.3 | 50 |
| 31 | | | | | | | | | | | 33.3 |
| 32 | | | | | | | | | | | |
| 33 | | | | | | | | | | | |
| 34 | | | | | | | | | | | |
| 35 | | | | | | | | | | | |
| 36 | | | | | | | | | | | |
| 37 | | | | | | | | | | | |
| 38 | | | | | | | | | | | |
| 39 | | | | | | | | | | | |
| 40 | | | | | | | | | | | |
| 41 | | | | | | | | | | | |
| 42 | | | | | | | | | | | |
| 43 | | | | | | | | | | | |

| | License Renewal Term (years) | | | | | | | | |
|---|---|---|---|---|---|---|---|---|---|
| | 8 | | | 10 | | | 12 | | |
| | 3 of 51 States | | | 1 of 51 States | | | 1 of 51 States | | |
| Age of Driver | <1 | <2 | <3 | <1 | <2 | <3 | <1 | <2 | <3 |
| 16-18 | 100 | 100 | 100 | 100 | 100 | 100 | 100 | 100 | 100 |
| 19 | 100 | 100 | 100 | 100 | 100 | 100 | 100 | 100 | 100 |
| 20 | 100 | 100 | 100 | 100 | 100 | 100 | 100 | 100 | 100 |
| 21 | 100 | 100 | 100 | 100 | 100 | 100 | 100 | 100 | 100 |
| 22 | 100 | 100 | 100 | 100 | 100 | 100 | 100 | 100 | 100 |
| 23 | 100 | 100 | 100 | 100 | 100 | 100 | 100 | 100 | 100 |
| 24 | 100 | 100 | 100 | 100 | 100 | 100 | 100 | 100 | 100 |
| 25 | 100 | 100 | 100 | 100 | 100 | 100 | 100 | 100 | 100 |
| 26 | 100 | 100 | 100 | 100 | 100 | 100 | 100 | 100 | 100 |
| 27 | 50 | 50 | 50 | 50 | 100 | 100 | 100 | 100 | 100 |
| 28 | 50 | 50 | 50 | 50 | 50 | 100 | 100 | 100 | 100 |
| 29 | 50 | 50 | 50 | 50 | 50 | 50 | 100 | 100 | 100 |
| 30 | 50 | 50 | 50 | 50 | 50 | 50 | 50 | 50 | 50 |
| 31 | 50 | 50 | 50 | 50 | 50 | 50 | 50 | 50 | 50 |
| 32 | 50 | 50 | 50 | 50 | 50 | 50 | 50 | 50 | 50 |
| 33 | 33.3 | 50 | 50 | 50 | 50 | 50 | 50 | 50 | 50 |
| 34 | | 33.3 | 50 | 50 | 50 | 50 | 50 | 50 | 50 |
| 35 | | | 33.3 | 50 | 50 | 50 | 50 | 50 | 50 |
| 36 | | | | 50 | 50 | 50 | 50 | 50 | 50 |
| 37 | | | | 33.3 | 50 | 50 | 50 | 50 | 50 |
| 38 | | | | | 33.3 | 50 | 50 | 50 | 50 |
| 39 | | | | | | 33.3 | 50 | 50 | 50 |
| 40 | | | | | | | 50 | 50 | 50 |
| 41 | | | | | | | 33.3 | 50 | 50 |
| 42 | | | | | | | | 33.3 | 50 |
| 43 | | | | | | | | | 33.3 |

Note:
2 States have options where license holder can elect 4/8 or 2/4 year renewal term.
D.C. is considered a jurisdiction equivalent to a state, therefore, there are 51 states
The earliest license age is assumed to be age 16
Arizona issues driver licenses, for age 60 or less, that does not expire until age 65
Exceptions:
1. Drivers who moved to a new state and receive a new license, with a new valid date.
2. Licensed drivers that were suspended and/or revoked being issued a new license, with a new valid date.

Primary/Temporal Identifier #2: The number of years an applicant for auto insurance has had the elements characteristic of an issued adult driver's license and/or credit history file.

The information employed to set the weight or point value for this Primary/Temporal Identifier derives from: credit history records; Social Security/Tax Identification numbers; age; and/or address of the applicant.

A person needs to be age 18 and have an address to qualify for an adult driver license and/or establish credit history files in the US. Certain States also require applicants for a driver license to provide Social Security or Tax Identification Numbers. The Social Security Act allows states to use the Social Security number to establish the identification of an individual. A Social Security number is also an element useful in establishing a credit history or file. The year and state of issue of a social security number can be derived from tables of Social Security numbers, available via a governmental database.

Applicant's age, address and social security number are indicators of the possible start of a driving and/or credit history record. As described above in Example 1, an adult applicant with garaging address but who was issued a Social Security number within 3-5 years prior to application for automobile insurance is indicative of a driver with little or no driving experience in the U.S.

In one embodiment, the existence of a value for this Primary Identifier will trigger a request for verification by the writing agent.

Primary/Temporal Identifier #3: Existence/Non Existence of credit history and depth, which is the number of years since the first entry or account activity in a credit history report.

The Existence/Non Existence of credit and the depth of credit history has never been used to identify an applicant as a driver with less than a specified number of years of driving experience. Such specified period of years may be in the range 3-5 years. Credit (insurance score) inquiry responses such as “NO HIT” and “NO RECORD FOUND” are helpful indicators that an applicant may be an inexperienced adult operator/driver or a driver with unverifiable driving history but it is not an absolute indicator. Therefore, such an indicator can be used as part of a set of indicators to establish a probability related to the existence and verifiability of driving experience.

In one embodiment, a rating system assigns a weight or numerical point value based on the depth of applicant's credit history in years or some other reasonable term. The existence of a value for this Primary Identifier will trigger a request for verification by the writing agent.

Primary/Temporal Identifier #4: Having no prior auto insurance for any reason, within a specified period of years prior to application for insurance. This includes first time automobile owner or first time automobile insurance purchaser and the use of NO PRIOR/NO NEED submission, or other suitable declaration that explains the reason(s) for having no prior auto insurance. Such specified period of years may be in the range 3-5 years.

A common form used in applying for automobile insurance is called a No Prior/No Need form. It is completed by automobile insurance applicants in order to qualify for a discount or avoid a premium penalty for not having continuous automobile insurance in force. This is a helpful indicator that an applicant may be an inexperienced adult operator/driver but it is not an absolute indicator of inexperience. Acceptable reasons for not having prior insurance include: not previously owning or needing an automobile; returning to the U.S. from overseas military duty; returning from long-term work overseas; moving from a jurisdiction where automobile insurance was not compulsory; or medical reasons.

For example, this information is derived from a Current Carrier™ database, a database available from CHOICE POINT, and a Coverage Verifier^{SM} database, a database available from ISO, and similar databases that identify the existence of current and previous automobile insurance coverage, whether or not the applicant has had lapses or cancellations.

In one embodiment, a rating system will assign a weight or numerical point value based on whether or not this Primary Identifier was present. See, for example, Table 6 below. In one embodiment, the existence of a value for this Primary Identifier will trigger a request for verification by the writing agent.

Primary/Temporal Identifier #5: Applicant has held driver's learner's permit within a specified period of years prior to application. Such specified period of years may be in the range 3-5 years.

The fact that an adult applicant for automobile insurance has a recent history of a learner's permit is convincing evidence that the applicant is an inexperienced operator/driver or a driver with limited driving experience in the U.S. This information derives from the appropriate state department of motor vehicle (DMV) records. In one embodiment, a rating system assigns a high weight or numerical point value based on whether or not this Primary Identifier was present.

Primary/Temporal Identifier #6: Applicant has a violation on record for driving without a license within a specified period of years prior to application. Such specified period of years may be in the range 3-5 years.

This factor has never been used to identify an applicant as inexperienced operator/driver or driver with unverifiable driver history. This information is available from the appropriate state department of motor vehicle (DMV) records. A rating system assigns a weight or numerical point value based on whether or not this Primary Identifier was present.

Exception Identifiers

Exception Identifier #1: At time of auto insurance application, applicant has current US driver's license valid for more than a specified period of years. Such specified period of years may be in the range 3-5 years.

The date of issue and/or expiration of an applicant's current valid driver license is documented on the individual driver licenses held by applicants and can be elicited by questions asked on an application for automobile insurance. The information provided can be collaborated and verified by the individual state department of motor vehicle (DMV) records. In one embodiment, a rating system assigns a negative weight or numerical point value based on whether or not this Exception Identifier was present. See, for example, Table 9 below.

Exception Identifier #2: At time of auto insurance application, applicant has the existence of traffic ticket(s), on the applicant's driving record, for moving violations older than a specified period of years. Such specified period of years may be in the range 3-5 years.

This information is derived from the Motor Vehicle Record (MVR) from the applicant's Department of Motor Vehicles (DMV), the Comprehensive Loss Underwriting Exchange (a report identified as CLUE® and available from CHOICE POINT), and Automobile-Property Loss Underwriting Service (A-PLUS™) reports, a report available from ISO, and other similar databases. A moving violation or a ticket on record for driving without a valid driver's license, within the same specified period of years would void any credit in the rating system.

The existence of traffic ticket(s) on the applicant's driving record has not been used as a tool to isolate and identify inexperienced operators/drivers or automobile insurance applicants with an unverifiable driving history. In one embodiment, a rating system assigns a negative weight or numerical point value based on whether or not this Exception Identifier was present.

Exception Identifier #3: The existence of one or more accident occurrences, on the applicant's driving record, older than a specified period of years, prior to the date of application for auto insurance. Such specified period of years may be in the range from 3-5 years.

This information is derived from the Motor Vehicle Record (MVR) from the applicant's Department of Motor Vehicles (DMV), Comprehensive Loss Underwriting Exchange (a report identified as CLUE® and available from CHOICE POINT), and Automobile-Property Loss Underwriting Service (A-PLUS™) reports, a report available from ISO, and other similar databases. A moving violation or ticket on record for driving without a valid driver's license, within the same specified period of years would void any credit in the rating system.

The existence of accident(s) on the applicant's driving record has not been used as a tool to isolate and identify inexperienced operators/drivers or automobile insurance applicants with an unverifiable driving history. In one embodiment, a rating system assigns a negative weight or numerical point value based on whether or not this Exception Identifier was present.

Exception Identifier #4: The existence of prior automobile insurance coverage, older than a specified period of years, prior to the date of application for auto insurance. Such specified period of years may be in the range 3-5 years.

This information is derived from a Current Carrier™ database, a database available from CHOICE POINT, and a Coverage Verifier^{SM} database, a database available from ISO, and similar data bases which identify the existence of current and previous automobile insurance coverage and whether or not the applicant has had lapses or cancellations. A moving violation or ticket on record for driving without a valid driver's license, within the same specified period of years would void any credit in the rating system.

The existence of prior auto insurance history has not been used to isolate and identify inexperienced operators/drivers or automobile insurance applicants with an unverifiable driving history. In one embodiment, a rating system assigns a negative weight or numerical point value based on whether or not this Exception Identifier was present.

Other Identifiers

Other Primary/Temporal Identifiers and Exception Identifiers can be identified that can be employed to establish a probability that an adult driver has either (1) the characteristic of being inexperienced operator or (2) the characteristic of having only driving experience gained outside of the U.S. In one embodiment, verifiable data indicative of the applicant having driving experience in Canada is employed as an exception identifier. In this regard, driving experience in Canada correlates to U.S. driving experience for some U.S. insurance companies, such that verifiable driving experience in Canada offsets the temporal identifiers based on U.S.-only data.

Identifying data for drivers that have been verified as experienced by the present invention can be placed in an experienced operator/driver data base. This data base can be used as a Primary or Exception Identifier in subsequent automobile underwriting inquiries regarding such drivers to determine their experience status. This will result in the use of a single summary Identifier and in a simpler, possibly lower cost, process.

In addition, other data sources exist that are useful in identifying additional identifiers. For example, states might be encouraged to include on the driver's licenses they issue an original first issue date for a driver's license in that state. Or, states might begin to include information indicating if a driver's license was an original issue, renewal issue, or was issued to a new resident replacing a driver's license previously issued by another state. Such data contained in state driver's license issuing departments could be used to create additional primary identifiers which might be used to enhance or replace primary identifiers described above.

In addition, insurance companies, credit vendors, or other entities may choose to create data records based on state driver's license records which, through a merging and comparison process, might create new summarized and correlated data records which might form the basis for a new or enhanced primary indicator which might be useful in the present invention.

Similarly, credit records might be merged and compared so as to create a new and useful data base for a new or enhanced primary indicator. A new data base useful as a source for a primary indicator could be created by downloading and correlating historical driver's license, credit history, or other similar data files to form a new data file.

### EXAMPLE 2

Multiple Temporal and Exception Identifiers Employed to Classify Applicant

The following examples illustrate how the present invention can be employed in one embodiment. This example is used to identify inexperienced drivers who are defined as drivers with less than three years of driving experience. However, other definitions of inexperienced drivers can be used. For example, an inexperienced driver might be defined as a driver with less than 5 years of driving experience.

Define a set of Primary Identifiers that have a direct or indirect relationship to the number of years of driving experience that an applicant for auto insurance may have. Such Primary Identifiers are selected such that they can be easily verified from information data bases readily available to an automobile insurance writer.

Establish for each Identifier a numerical value where:
An appropriate numerical value is assigned based on a “year” variable.
The “year” variable is determined based on a category which represents the number of years for which the Primary Identifier has existed for the automobile insurance applicant.
Such numerical values are determined based on a reference to the appropriate information data base.

Define a set of Exception Identifiers which offset or negate information provided by the Primary Identifier data bases. Such Exception Identifiers are either assigned a numerical value to be subtracted from the sum of the Primary Identifier numerical values; or the existence of an Exception Identifier is used to reduce to zero all Primary Identifier value.

The sum of the Primary Identifier values less Exception Identifier values, or the net sum, indicates the degree of probability that an auto insurance applicant is inexperienced or is likely to have only driving experience outside of the U.S. A probability factor or numerical point value is associated with such net sum value.

The point value or the probability factor is used to drive underwriting follow-up to be applied by the insurance agent or agency involved in the auto insurance sale. This is called directed field underwriting.

Such directed field underwriting follow-up will either confirm or modify the presumption of inexperience or non-U.S. and non-Canadian driving experience derived from the net sum.

This method may be implemented on a computer via the coding of computer-executable instructions and may utilize computer networks such as the Internet or an intranet in order to facilitate the transmission and recording of data and the transmission of the results of applying the method.

Evaluation of Primary/Temporal Identifiers

Example data: The example considers two applicants, Applicant A and Applicant B, for insurance. Both are in Washington and both are age 28. At time of auto insurance application, Applicant A's current driver's license has been valid for 1 year and 11 months and Applicant B's current driver's license has been valid for 10 months.

Primary/Temporal Identifier #1: Valid License Duration (period of time the current driver's license has been valid prior to application for auto insurance) can be assigned a point value by the following evaluation:
Washington is a state with a 5 year license renewal period.
For age 28, per the Inexperienced Operator Identifier Table (Table 2), Applicant A with a current valid driver's license for 1 year, 11 months would get a probability assignment of 50%.

Applicant B with a current valid driver's license for 10 months would get a probability assignment, per the table, of less than 33.3%.

TABLE 3

| Probability assigned from Table - | | | |
|---|---|---|---|
| Based on Number of Years | | | |
| Current Driver's License | | | |
| was valid | Points | Applicant A | Applicant B |
| 100% | 10 | — | — |
| 50% | 8 | 8 | — |
| <50% | 0 | — | 0 |

Example data: At time of auto insurance application, Applicant A had elements characteristic of those for issuance of an adult driver license and/or establish credit history for 4 years, while the same elements were present for Applicant B for 6 years.

Primary/Temporal Identifier #2: License Elements Duration (# of years elements characteristic of those for issuance of an adult driver license and/or for the establishment of a credit history were in place prior to application for auto insurance) can be assigned a point value per Table 4.

TABLE 4

| # of Years Elements | | | |
|---|---|---|---|
| Exist for Adult Driver | | | |
| license and/or Credit History | Points | Applicant A | Applicant B |
| Years ≦ 0 | 7 | — | — |
| 0 < Years ≦ 3 | 6 | — | — |
| 3 < Years ≦ 5 | 5 | 5 | — |
| 5 < Years ≦ 7 | 4 | — | 4 |
| 7 < Years | 0 | — | — |

Example data: At the time of auto insurance application, Applicants A has 4 years of credit depth defined by first entry or account activity in credit history report and Applicant B's insurance score (credit) inquiry came back “NO HIT”/“NO RECORD FOUND”.

Primary/Temporal Identifier #3: Credit Duration (Existence/Non Existence of a credit history and depth) can be assigned a point value per Table 5:

TABLE 5

| # of Years Since First Entry, | | | |
|---|---|---|---|
| Activity in Credit History | Points | Applicant A | Applicant B |
| NO HIT/NO RECORD FOUND | 7 | — | 7 |
| 0 < Years ≦ 3 | 6 | — | — |
| 3 < Years ≦ 5 | 5 | 5 | — |
| 5 < Years ≦ 7 | 4 | — | — |
| 7 < Years | 0 | — | — |

Example data: At the time of auto insurance application, Applicant A owned a car and has proof of prior and continuous auto insurance, while applicant B is purchasing a car and auto insurance for the first time and has submitted a NO PRIOR/NO NEED form with the insurance application.

Primary/Temporal Identifier #4: No-Prior No-Need (NPNN) Submission (having no prior auto insurance for any reason within previous 3 years, first time auto owner or insurance purchaser) can be assigned a point value per Table 6:

TABLE 6

| Having no prior auto insurance, | | | |
|---|---|---|---|
| First Time Auto Owner | | | |
| and/or Insurance Purchaser | | | |
| No Prior/No Need Form | Points | Applicant A | Applicant B |
| YES | 5 | — | 5 |
| NO | 0 | 0 | — |

Example data: At the time of auto insurance application both applicants possessed regular driver licenses and neither had a learner's permit during the previous 3 years.

Primary/Temporal Identifier #5: Learner Permit Duration (applicant has held driver's learner's permit within the previous 3 years period prior to application for auto insurance) can be assigned a point value per Table 7:

TABLE 7

| Applicant has held Driver's | | | |
|---|---|---|---|
| Learner's Permit | | | |
| in the prior 3 years | Points | Applicant A | Applicant B |
| YES | 10 | — | — |
| NO | 0 | 0 | 0 |

Example data: At time of auto insurance application both applicants do not have moving violations for driving without a license.

Primary/Temporal Identifier #6: No License Violation Duration (violation for driving without a license in previous three years) can be assigned a point value per Table 8:

TABLE 8

| Applicant has Violation | | | |
|---|---|---|---|
| for Driving without a | | | |
| license in prior 3 years | Points | Applicant A | Applicant B |
| YES | 10 | — | — |
| NO | 0 | 0 | 0 |

Exception Identifiers are indicated with positive point values which are subtracted from the sum total of Primary Identifier values.

Evaluation of Exception Identifiers

Example data: At time of the auto insurance application both applicants have driver's licenses with valid dates of less than 3 years.

Exception Identifier #1: Evidence of Prior Valid License In one embodiment, an applicant having a current U.S. driver's license valid for more than three years at time of auto insurance application can be assigned a point value per Table 9. In another embodiment, an applicant having a Canadian driver's license valid for more than three years at time of auto insurance application can be assigned a point value.

TABLE 9

| Applicant has current U.S. Driver's | | | |
|---|---|---|---|
| License valid for more than | | | |
| 3 years at time of application | Points | Applicant A | Applicant B |
| YES | 15 | — | — |
| NO | 0 | 0 | 0 |

Example data: At time of auto insurance application, Applicant A's driving record for past 5 years shows a moving violation for speeding ticket 4.5 years ago, while Applicant B's record shows no moving violations or traffic tickets in the same period.

Exception Identifier #2: Evidence of Prior Violations (traffic tickets for moving violations older than 3 years, other than for driving without a license on applicant's record) can be assigned a point value per Table 10:

TABLE 10

| Applicant has Traffic Tickets for | | | |
|---|---|---|---|
| moving violations older than 3 years | | | Applicant |
| (other than driving without a license) | Points | Applicant A | B |
| YES | 10 | 10 | — |
| NO | 0 | — | 0 |

Example data: At time of auto insurance application both applicants have no accidents on record older than 3 years.

Exception Identifier #3: Evidence of Accident Record (existence of accident(s) on applicant's record older than 3 years and not accompanied by a ticket for driving without a license) can be assigned a point value per Table 11:

TABLE 11

| Applicant has an Accident on | | | |
|---|---|---|---|
| Record older than 3 years | Points | Applicant A | Applicant B |
| YES | 10 | — | — |
| NO | 0 | 0 | 0 |

Example data: At time of auto insurance application both applicants have no history of prior insurance on record older than 3 years.

Exception Identifier #4: Evidence of Prior Vehicle Insurance (existence of prior automobile insurance older than 3 years from date of application) can be assigned a point value per Table 12:

TABLE 12

| Applicant has history of prior auto | | | |
|---|---|---|---|
| insurance older than 3 years | Points | Applicant A | Applicant B |
| YES | 10 | — | — |
| NO | 0 | 0 | 0 |

The above set of Primary and Exception Identifiers are applied to the following applicants as discussed above. A net sum of 10 or more implies a high probability of being an inexperienced driver or a driver with an unverifiable driving history.

Table 13 summarizes the total point values with respect to each of the example drivers—Applicant A and Applicant B:

TABLE 13

| | | Applicant A | Applicant B |
|---|---|---|---|
| Primary Identifiers | | | |
| 1. | From probability Table. Period of time current driver's | 8 | 0 |
| | license has been valid | | |
| 2. | # of years elements for adult driver license and | 5 | 4 |
| | establishment of a credit history were in place | | |
| 3. | Existence of credit history and depth | 5 | 7 |
| 4. | No prior auto insurance, First time auto owner or | 0 | 5 |
| | insurance purchaser, NO PRIOR/NO NEED | | |
| | SUBMISSION | | |
| 5. | Applicant recent history shows a driver's learner's | 0 | 0 |
| | permit | | |
| 6. | Violation for driving without a license previous 3 years | 0 | 0 |
| | TOTAL - Primary Identifiers | 18 | 16 |
| Exception Identifiers | | | |
| 1. | Applicant has a current valid U.S. driver's license | 0 | 0 |
| | more than three years old | | |
| 2. | Traffic tickets for moving violations older than 3 years | 10 | 0 |
| | on applicant's record | | |
| 3. | Existence of accident record older than 3 years | 0 | 0 |
| 4. | Existence of auto insurance more than 3 years old | 0 | 0 |
| | TOTAL - Exception Identifiers | 10 | 0 |
| | TOTAL Rating System Value | 8 | 16 |

In one embodiment, a reference table is created in which 10 points or higher indicates the applicant as being of high risk to be inexperienced adult operator/driver or a driver with unverifiable driving history. Therefore, less than 10 points means a driver was unlikely to fall into that category.

Therefore, Applicant A with a net sum of 8 is determined to be a driver with a low probability of being an inexperienced adult driver or a driver with unverifiable driving history.

Applicant B with net sum of 16 is identified as having a high probability of being an inexperienced adult driver or a driver with unverifiable driving history.

Alternatively, rather than point numerical values being assigned as described above, percentage numerical values might be assigned such that a higher percentage is indicative of a greater likelihood that an adult driver was inexperienced or had an unverifiable driving record. In such a system the reference table might be a table of percentages ranging from 0% to 100% such that, say, a numerical percentage value of 60% might be indicative of being an inexperienced adult driver or a driver with unverifiable driving history.

Other reference tables with other ranges of values and different levels which indicate a high probability that a driver is an inexperienced adult driver or a driver with unverifiable driving history can be developed for other appropriate sets of Primary Identifiers and Exception Identifiers.

### EXAMPLE 3

A Single Temporal Identifier and a Single Exception Identifier is Employed to Classify Applicant

Temporal Identifier Valid License Duration

Washington is a state with a 5 year license renewal period.
For age 23, per the Inexperienced Operator Identifier Table (Table 2), Applicant A with a current valid driver's license for 2 years, 3 months would get a probability assignment of 100%.

Applicant B, age 23, with a current valid driver's license for 10 months would get a probability assignment, per the table, of 50%.

TABLE 14

| Probability assigned from Table 2 - | | | |
|---|---|---|---|
| Based on Number of Years Current | | | |
| Driver's License was valid | Points | Applicant A | Applicant B |
| 100% | 10 | 10 | — |
| 50% | 8 | — | 8 |
| <50% | 0 | — | 0 |

Example data: At time of auto insurance application, both applicants have an issued driver license with valid dates of less than three years.

Exception Identifier: Evidence of Prior Valid License (applicant has a current U.S. driver's license valid for more than three years at time of auto insurance application) is assigned a point value per Table 9:

TABLE 15

| Applicant has current U.S. Driver's | | | |
|---|---|---|---|
| License valid for more than 3 years | | | |
| at time of application | Points | Applicant A | Applicant B |
| YES | 15 | — | — |
| NO | 0 | 0 | 0 |

Example data: At time of auto insurance application, both applicants have an issued driver license with valid dates of less than three years.

For Applicant A, the total of the temporal identifiers is 10; for Applicant B, the total of the temporal identifiers is 8. For Applicants A and B, the total of the exception identifiers is 0. In one embodiment, the rating system for Applicant A has a value of 10, and the rating system for Applicant B has a value of 8.

In one embodiment, a reference table is created in which a rating of 10 points or higher indicates the applicant as being of high risk to be inexperienced adult operator/driver or a driver with unverifiable driving history, and a rating of between zero and 10 points indicates that the driver is likely an experienced adult driver, and a negative rating likely indicates an experienced driver.

Therefore, Applicant A with a net sum of 10 has a probability of being an inexperienced adult driver or a driver with unverifiable driving history. Applicant B with net sum of 8 is identified as having a lower probability of being an inexperienced driver.

### EXAMPLE 4

A Single Temporal Identifier Employed to Classify Applicant

Primary/Temporal Identifier #4: No-Prior No-Need (NPNN) Submission (having no prior auto insurance for any reason within previous 3 years, first time auto owner or insurance purchaser). In one embodiment, an NPNN submission by the applicant indicates the applicant has a high probability of being an inexperienced adult driver or a driver with unverifiable driving history. In another embodiment, the existence of an NPNN submission is assigned a point value per Table 16. In the case where there is no exception identifier to offset the information contained in the NPNN submission, the high point value of temporal identifier #4 is indicative that the applicant has a high probability of being an inexperienced adult driver or a driver with unverifiable driving history.

TABLE 16

| Having no prior auto insurance, First | | | |
|---|---|---|---|
| Time Auto Owner and/or Insurance | | Applicant | Applicant |
| Purchaser No Prior/No Need Form | Points | A | B |
| YES | 10 | — | 10 |
| NO | 0 | 0 | — |

Example data: At the time of auto insurance application, Applicant A owns a car and has proof of prior and continuous insurance, while Applicant B is purchasing a car and auto insurance for the first time and has submitted a No Prior/No Need form with the insurance application.

In one embodiment, a reference table is created in which 10 points or higher indicates the applicant as being of high risk to be inexperienced adult operator/driver or a driver with unverifiable driving history. Therefore, less than 10 points would mean a driver was unlikely to fall into that category.

Therefore, based upon one temporal identifier alone, Applicant A with a net sum of 0 is determined to be a driver with a low probability of being an inexperienced adult driver or a driver with unverifiable driving history.

Applicant B with net sum of 10 is identified as having a high probability of being an inexperienced adult driver or a driver with unverifiable driving history.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of evaluating insurance risk of a vehicle insurance applicant, the method comprising:
identifying a plurality of temporal identifiers related to acquired driving experience for the applicant, the temporal identifiers selected from the group consisting of valid license duration, license elements duration, credit duration, no-need no-prior submission, learner permit duration, no license violation duration;
assigning a value to each of the identified temporal identifiers;
identifying a plurality of exception identifiers related to a driving record of the applicant, the exception identifiers selected from the group consisting of evidence of prior valid license, evidence of prior violations, evidence of accident record, and evidence of prior vehicle insurance;
assigning a value to each of the identified exception identifiers;
calculating a driver rating based upon the value assigned to each of the temporal and exception identifiers; and
classifying the applicant into one of an inexperienced adult driver category, an unverifiable driving history category, and an inexperienced driver category based upon the driver rating.

2. The method of claim 1, wherein the step of identifying a plurality of temporal identifiers comprises identifying a recorded driving history for the applicant of less than three years; and the step of classifying the applicant comprises classifying the applicant into the inexperienced driver category.

3. The method of claim 1, wherein the step of assigning a value to each of the identified temporal identifiers comprises assigning one of an arbitrary value and a lookup value to each of the identified temporal identifiers.

4. The method of claim 1, wherein the step of assigning a value to each of the identified exception identifiers comprises assigning one of an arbitrary value and a lookup value to each of the identified exception identifiers.

5. The method of claim 1, wherein the step of calculating a driver rating comprises:
summing the values for the identified temporal identifiers;
summing the values for the identified exception identifiers; and
subtracting the sum of the values for the identified exception identifiers from the sum of the values for the identified temporal identifiers of the applicant.

6. The method of claim 1, wherein the step of calculating a driver rating comprises calculating a probability factor related to a risk level in underwriting an insurance policy for the applicant.

7. The method of claim 1, further comprising:
using an electronic device in accessing a client-server system to retrieve driver record data of the applicant from the client-server system.

8. The method of claim 7, wherein the step of accessing a client-server system comprises accessing a distributed communication system.

9. The method of claim 7, wherein the step of accessing the client-server system comprises accessing a distributed communication system configured to query a separate program at a host on the distributed communication system.

10. The method of claim 1, further comprising:
underwriting an insurance policy for the applicant based on results obtained from the step of classifying the applicant.

11. A method of evaluating an applicant for vehicle insurance, the method comprising:
collecting a social security number supplied by the applicant;
analyzing the social security number to determine a date of issuance of the social security number; and
classifying the applicant into one of an inexperienced adult driver category, an unverifiable driving history category, and an inexperienced driver category based upon the social security number.

12. The method of claim 11, wherein the step of analyzing the social security number comprises accessing one of a government database and a lookup table database.

13. The method of claim 12, wherein the step of analyzing the social security number comprises electronically retrieving from a client-server system data related to one of an area number, a group number, and a serial number of the social security number.

14. The method of claim 13, wherein the data related to one of an area number, a group number, and a serial number of the social security number comprises geographical region data related to a mailing address of the applicant to which the social security number was issued.

15. The method of claim 14, wherein the step of classifying the applicant comprises classifying the applicant based on the geographical region data.

16. The method of claim 13, wherein the data related to one of an area number, a group number, and a serial number of the social security number comprises data related to a year the social security number was issued to the applicant.

17. A vehicle insurance underwriting system comprising:
a computer system; and
a program operable by the computer system to:
calculate a driver rating based upon comparing a plurality of temporal identifiers related to acquired driving experience for the applicant relative to a plurality of exception identifiers related to a driving record of the applicant, and
classify the applicant into at one of an inexperienced adult driver category, an unverifiable driving history category, and an inexperienced driver category based upon the driver rating.

18. The system of claim 17, wherein the program calculates the driver rating by assigning a value to each exception identifier and each temporal identifier, summing the exception identifier values and summing the temporal identifier values, and subtracting the sum of the exception identifier values from the sum of the temporal identifier values.

19. The system of claim 18, wherein the program calculates the driver rating by offsetting an assigned temporal identifier value with an assigned exception identifier value.

20. The system of claim 18, wherein the program calculates the driver rating by setting to zero a value for one of the temporal identifiers.
